(19) United States
(12) Patent Application Publication
(10) Pub. No.: US 2006/0250055 A1
(43) Pub. Date: Nov. 9, 2006

(54) Tool storage cabinet with a lock assembly

(76) Inventor: George C.M. Liu, Yunlin Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/121,460

(22) Filed: May 4, 2005

(51) Int. Cl. E05B 53/00

(52) U.S. Cl. 312/218

(57) ABSTRACT

A tool storage cabinet has a body, multiple tracks, multiple drawers, a lock assembly and a top cover. The body has a front panel, two side panels and a rear panel. The front panel has a hollow upper rod, two hollow side rods and a lower rod. The lock assembly is attached to the body and has a combination lock cylinder, a driving tab, two levers and two locking tabs. The combination lock cylinder is attached to the upper rod. The driving tab is attached to and rotates with the lock cylinder. The levers are pivotally connected to the driving tab and are pivotally connected to the upper rod. The locking rods are slidably mounted respectively inside the side rods and are pivotally connected respectively to the levers. Each locking rod has multiple locking tabs corresponding respectively to the tracks.

### BACKGROUND OF THE INVENTION

1. Field of the Invention

The present invention relates to a tool storage cabinet, and more particularly to a tool storage cabinet with a lock assembly that is convenient in use.

2. Description of Related Art

To conveniently store tools to enable a user to easily take and use the tools, a tool storage cabinet is commonly used in a factory, workshop, etc. A conventional tool storage cabinet substantially comprises a body and multiple drawers slidably mounted in the body to hold tools inside. A lock assembly is mounted in the body to keep the drawers from being arbitrarily opened and the tools from being unauthorizedly used. When the user wants to use the tools in the cabinet, the lock assembly must be unlocked with a specific key. However, if the user forgets to carry the key or the key has been lost, the authorized user cannot unlock the cabinet and use the tools.

To overcome the shortcomings, the present invention tends to provide a tool storage cabinet to mitigate or obviate the aforementioned problems.

### SUMMARY OF THE INVENTION

The main objective of the invention is to provide a tool storage cabinet that is convenient in use. The tool storage cabinet has a body, multiple tracks, multiple drawers, a lock assembly and a top cover. The body has an open top, a bottom, a front panel, two side panels and a rear panel. The front panel is composed of a hollow upper rod, two hollow side rods and a lower rod to define a front opening in the front panel. The side panels are connected respectively to the side rods of the front panel. The rear panel is mounted between the side panels. The tracks are mounted respectively on the side panels in parallel and align with one of the others. The drawers are slidably mounted inside the body between the side panels, and each is attached between a pair of aligning tracks. The lock assembly is attached to the body and has a combination lock cylinder, a driving tab, two levers and two locking tabs. The combination lock cylinder is attached to the upper rod. The driving tab is attached to and rotates with the lock cylinder and is mounted inside the upper rod. The levers are pivotally connected to two ends of the driving tab, extend respectively toward the side rods and are pivotally connected to the upper rod. The locking rods are slidably mounted respectively inside the side rods and are pivotally connected respectively to the levers. Each locking rod has multiple locking tabs extending through a corresponding side rod and into the front opening and corresponding respectively to one of the tracks. The top cover is attached to the top of the body to close the open top of the body.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a tool storage cabinet in accordance with the present invention;

FIG. 2 is a front view of the lock assembly of the tool storage cabinet in FIG. 1;

FIG. 3 is an enlarged operational front view of the lock assembly in FIG. 2 showing that the lock assembly is unlocked;

FIG. 4 is an operational front view of the lock assembly in FIG. 2 showing that the lock assembly is unlocked; and

FIG. 5 is an enlarged front plan view of the lock assembly in FIG. 2.

### DETAILED DESCRIPTION OF PREFERRED EMBODIMENT

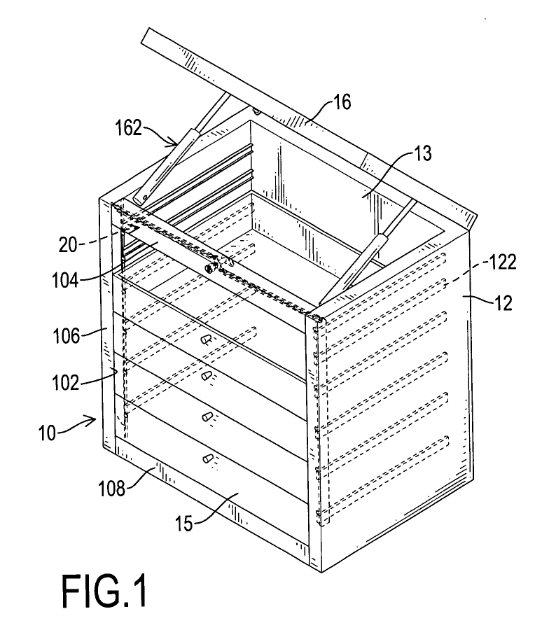

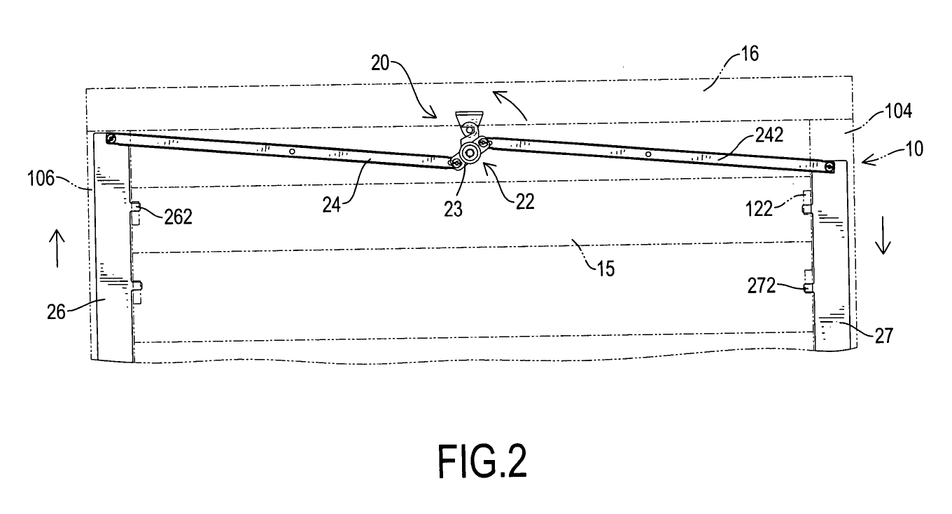

With reference to FIGS. 1 and 2, a tool storage cabinet in accordance with the present invention comprises a body, multiple tracks (122), multiple drawers (15), a lock assembly (20) and a top cover (16).

The body has an open top and a bottom and comprises a front panel (10), two side panels (12) and a rear panel (13). The front panel (10) is composed of a hollow upper rod (104), two hollow side rods (106) and a lower rod (108) to define a front opening (102) in the front panel (10). The side panels (12) are connected respectively to the side rods (106) of the front panel (10). The rear panel (13) is mounted between the side panels (12) and opposite to the front panel (10) such as to define an open top and an open bottom between the panels (10,12,13). A bottom panel is provided to close the open bottom, and the bottom panel can be a separate element or the bottom of a lowermost drawer.

The tracks (122) are mounted respectively on the side panels (12) in parallel and align with one of the others. The drawers (15) are slidably mounted inside the body between the side panels (12) and each is attached between a respective pair of the tracks (122).

The lock assembly (20) is attached to the body and comprises a combination lock cylinder (22), a driving tab (23), two levers (24,242) and two locking rods (26,27). The combination lock cylinder (22) is attached to the upper rod (104), and can be rotated when it is switched to a specific code or set of numbers. The driving tab is (23) attached to and rotates with the lock cylinder (22) and is mounted inside the upper rod (104). The levers (24,242) are pivotally connected to two ends of the driving tab (23), extend respectively toward the side rods (106) and are pivotally connected to the upper rod (104). In a preferred embodiment, each lever (24,242) is pivotally connected to the upper rod at the middle of the lever (24,242). The locking rods (26,27) are slidably mounted respectively inside the side rods (106) and are pivotally connected respectively to the levers (24,242). Each locking rod (26,27) has multiple locking tabs (262,272) extending through a corresponding side rod (106) and into the front opening (102) and corresponding respectively to the tracks (122). Each side rod (106) has multiple slits through which the locking tabs (262,272) of the corresponding locking rod (26,27) extend.

The top cover (16) is attached to the top of the body to close the open top of the body.

When the lock assembly (20) is in a locking condition, the locking tabs (262,272) respectively align with and block the tracks (122), such that tracks (122) are kept from sliding relative to the body and the drawers (15) cannot be opened. Accordingly, tools stored inside the drawers (15) will not be arbitrarily taken and used.

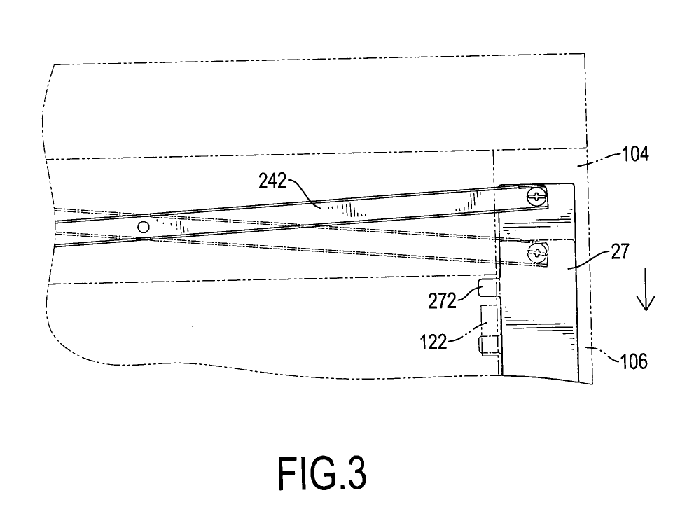

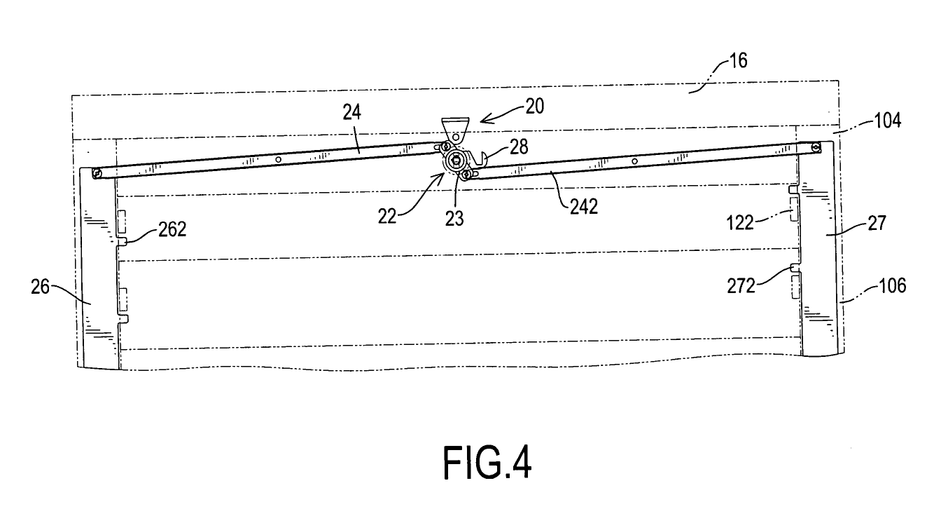

When the lock assembly (20) is unlocked by means of switching the lock assembly with a specific code or set of numbers, with reference to FIGS. 3 and 4, the lock cylinder (22) can be rotated and the driving tab (23) will rotate with the lock cylinder (22). With the rotation of the driving tab (23), the levers (24,242) will swing relative to the upper rod (104), and the locking rod (26,27) will move upward and downward to make the locking tabs (262,272) leave the place from where they align and block the tracks (122). Consequently, the drawers (15) can be opened, and the user can take and use the tools in the drawers (15).

In such an arrangement, the user can lock or unlock the lock assembly (20) without any key whereby to carry a specific key is not necessary for a user. Therefore, to use the tool storage cabinet with a lock assembly (20) in accordance with the present invention is convenient and easy.

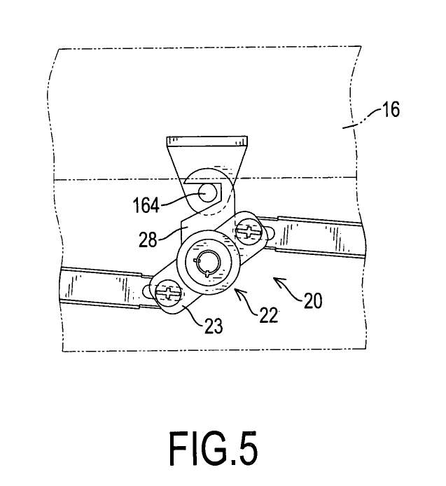

In addition, with reference to FIGS. 1, 2 and 5, the top cover (16) is pivotally attached to the top of the body. The two cylinders (162) are attached between the upper rod (104) and the top cover (16) to support the top cover (16). The top cover (16) has a latch rod (164), and a hook (28) is attached to and rotates with the lock cylinder (22) to selectively hook on the latch rod (164) on the top cover (16). With the engagement between the hook (28) and the latch rod (164), the top cover (16) is locked and cannot be opened to keep tools from being unauthorizedly taken. When the lock assembly (20) is unlocked and the lock cylinder (22) is rotated, the hook (28) will rotate with the lock cylinder (22) and release the latch rod (164) so that the top cover (16) is unlocked simultaneously.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tool storage cabinet comprising:
a body having an open top and a bottom and comprising
a front panel composed of a hollow upper rod, two hollow side rods and a lower rod to define a front opening in the front panel;
two side panels connected respectively to the side rods of the front panel; and
a rear panel mounted between the side panels;
multiple tracks mounted respectively on the side panels in parallel and aligning with one of the others;
multiple drawers slidably mounted inside the body between the side panels and each attached between an aligned pair of the multiple tracks;
a lock assembly attached to the body and comprising
a combination lock cylinder attached to the upper rod;
a driving tab attached to and rotating with the lock cylinder and mounted inside the upper rod;
two levers pivotally connected to two ends of the driving tab, extending respectively toward the side rods and pivotally connected to the upper rod; and
two locking rods slidably mounted respectively inside the side rods and pivotally connected respectively to the levers, each locking rod having multiple locking tabs extending through a corresponding side rod and into the front opening and corresponding respectively to the tracks; and
a top cover attached to the top of the body to close the open top of the body.

2. The tool storage cabinet as claimed in claim 1, wherein the top cover is pivotally attached to the top of the body.

3. The tool storage cabinet as claimed in claim 2, wherein two cylinders attached between the upper rod and the top cover to support the top cover.

4. The tool storage cabinet as claimed in claim 3, wherein
the top cover has a latch rod; and
a hook attached to and rotating with the lock cylinder to selectively hook on the latch rod on the top cover.

5. The tool storage cabinet as claimed in claim 2, wherein
the top cover has a latch rod; and
a hook attached to and rotating with the lock cylinder to selectively hook on the latch rod on the top cover.
